(19) United States
(12) Patent Application Publication
(10) Pub. No.: US 2025/0100642 A1
(43) Pub. Date: Mar. 27, 2025

(54) REMOVABLE FENDER FOR A BICYCLE

(71) Applicant: Timothy Spells, Lansing, IL (US)

(72) Inventor: Timothy Spells, Lansing, IL (US)

(21) Appl. No.: 18/898,507

(22) Filed: Sep. 26, 2024

Related U.S. Application Data
(60) Provisional application No. 63/540,876, filed on Sep. 27, 2023.

(51) Int. Cl. B62J 15/02

(52) U.S. Cl. CPC B62J 15/02

(57) ABSTRACT

A rear fender for a bicycle includes a fender body having a first end, and a second end arranged opposite to the first end; a seat attachment strap coupled to the first end of the fender body; a first frame attachment strap coupled to a first side of the fender body at a first fender location between the first end and the second end; and a second frame attachment strap coupled to a second side of the fender body, opposite to the first side, at a second fender location between the first end and the second end. The fender body defines a curved profile as the fender body extends from the first end to the second end.

### CROSS-REFERENCE TO RELATED PATENT APPLICATIONS

This application is based on and claims priority to U.S. Provisional Patent Application No. 63/540,876, filed on Sep. 27, 2023, which is incorporated herein by reference in its entirety.

### BACKGROUND

Fenders are typically used as a guard over a wheel to block debris and other material that is expelled from the wheel.

### SUMMARY

At least one embodiment relates to a rear fender for a bicycle. The rear fender includes a fender body having a first end and a second end arranged opposite to the first end, a seat attachment strap coupled to the first end of the fender body, a first frame attachment strap coupled to a first side of the fender body at a first fender location between the first end and the second end, and a second frame attachment strap coupled to a second side of the fender body, opposite to the first side, at a second fender location between the first end and the second end. The fender body defines a curved profile as the fender body extends from the first end to the second end.

At least one embodiment relates to a rear fender for a bicycle. The bicycle includes a seat tube, a seat coupled to the seat tube, a down tube extending outwardly from a first location on the seat tube, a first seat stay extending outwardly from a location on the seat tube between the first location and the seat, and a second seat stay extending outwardly from a location on the seat tube between the first location and the seat. The rear fender includes a fender body including a first end and a second end arranged opposite to the first end, a seat attachment strap coupled to the first end of the fender body and configured to removably attach to the seat tube, a first frame attachment strap coupled to the first side of the fender body at a first fender location between the first end and second end and configured to removably attach to the first seat stay, and a second frame attachment strap coupled to the first side of the fender body at a second fender location between the first end and the second end and configured to removably attach to the second seat stay. The fender body defines a curved profile as the fender body extends from the first end to the second end.

At least one embodiment relates to a rear fender for a bicycle. The rear fender includes a fender body having a first end and a second end arranged opposite to the first end, a center axis perpendicular to a longitudinal axis defined by the fender body, a seat attachment strap coupled to the first end of the fender body, a first frame attachment strap coupled to a first side of the fender body at a first fender location between the seat attachment strap and the center axis, a second frame attachment strap coupled to a second side of the fender body, opposite to the first side, at a second fender location between the seat attachment strap and the center axis. The fender body defines a curved profile as the fender body extends from the first end to the second end. The seat attachment strap is a hook and loop fastener. The first frame attachment strap is a hook and loop fastener. The second frame attachment strap is a hook and loop fastener. The first fender location is separated from the seat attachment strap by a first distance, and the second fender location is separated from the seat attachment strap by a second distance equal to the first distance.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a bicycle including a rear fender, according to an exemplary embodiment;

FIG. 2 is a side view of the bicycle and the rear fender FIG. 1;

FIG. 3 is a side view of the rear fender of FIG. 1;

FIG. 4 is a cross-sectional view of the rear fender taken along line 4-4 in FIG. 3;

FIG. 5 is a top view of the rear fender of FIG. 1;

FIG. 6 is a bottom view of the rear fender of FIG. 1;

FIG. 7 is a front view of the rear fender of FIG. 1;

FIG. 8 is a rear view of the rear fender of FIG. 1;

FIG. 9 is a cross-sectional view a seat attachment strap of the rear fender attached to a seat tube of the bicycle taken along line 9-9 in FIG. 2;

FIG. 10 is a cross-sectional view a first frame attachment strap of the rear fender attached to a first seat stay of the bicycle taken along line 10-10 in FIG. 2;

FIG. 11 is a cross-sectional view a second frame attachment strap of the rear fender attached to a second seat stay of the bicycle taken along line 11-11 in FIG. 2;

FIG. 12 is a cross-sectional view the rear fender taken along line 12-12 in FIG. 4, according to an exemplary embodiment;

FIG. 13 is a cross-sectional view the rear fender taken along line 13-13 in FIG. 4, according to an exemplary embodiment;

FIG. 14 is a perspective view of a bicycle including the rear fender of FIG. 1 and a water bottle holder, according to an exemplary embodiment; and

FIG. 15 is an enlarged view of the water bottle holder of FIG. 14.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The use herein of the term “axial” and variations thereof refers to a direction that extends generally along an axis of symmetry, a central axis, or an elongate direction of a particular component or system. For example, axially extending features of a component may be features that extend generally along a direction that is parallel to an axis of symmetry or an elongate direction of that component. Similarly, the use herein of the term “radial” and variations thereof refers to directions that are generally perpendicular to a corresponding axial direction. For example, a radially extending structure of a component may generally extend at least partly along a direction that is perpendicular to a longitudinal or central axis of that component. The use herein of the term “circumferential” and variations thereof refers to a direction that extends generally around a circumference or periphery of an object, around an axis of symmetry, around a central axis, or around an elongate direction of a particular component or system.

In general, the present disclosure relates to a rear fender for a bicycle that includes an attachment assembly that enables the rear fender to be universally attached to various frame structures on the bicycle. For example, bicycles may include frame structures (e.g., seat tube, seat stays, etc.) that vary in size and location depending on the type of bicycle. The rear fender of the present disclosure includes three attachments straps that removably attached to three different points on a bicycle frame. According to an exemplary embodiment, the three attachments straps may include a seat strap that removably coupled to a seat tube on a frame of a bicycle, and two side straps that removably coupled to one of the seat stays on the frame. The attachment straps may each include a hook and loop fastener (e.g., VELCRO®) that enables the straps to be easily installed around the respective portions of the frame (e.g., the seat tube and the seat stays) to secure the rear fender to the frame of the bicycle.

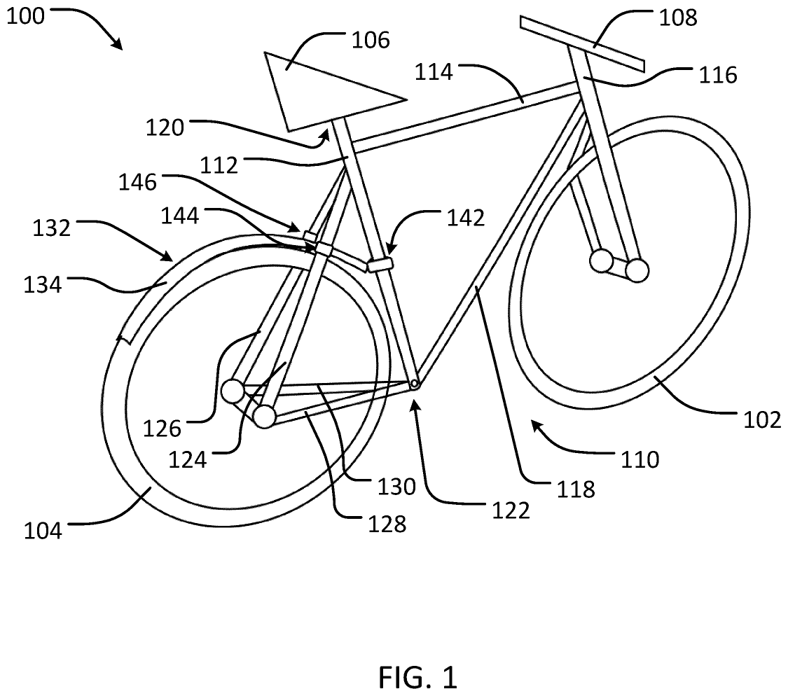

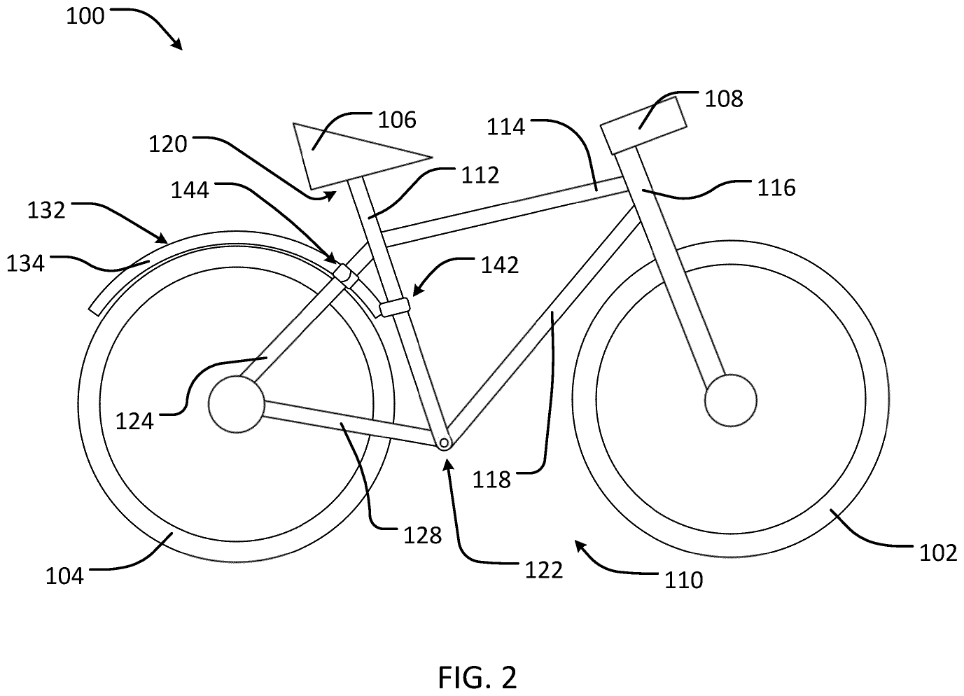

Referring to FIGS. 1 and 2, a bicycle 100 is shown according to an exemplary embodiment. The bicycle 100 includes a front wheel 102, a rear wheel 104, a seat 106, a handlebar 108, and a frame 110. The front wheel 102, the rear wheel 104, the seat 106, and the handlebar 108 are each coupled to or supported on the frame 110. In general, the frame 110 is formed by a plurality of tubes or frame members that are coupled to one another (e.g., welded together or integrally formed). For example, the frame 110 includes a seat tube 112, a top tube 114, a head tube 116, and a down tube 118. The head tube 116 is coupled to the handlebar 108, so that rotation of the handlebar 108 results in the same rotation of the head tube 116 and the front wheel 102, which is coupled to the head tube 116, to control the steering of the bicycle 100. A first end 120 of the seat tube 112 is coupled to the seat 106, and a second end 122 of the seat tube 112 is coupled to the down tube 118. The down tube 118 is coupled to and extends between the seat tube 112 and the head tube 116. The top tube 114 extends from a location on the seat tube 112 between the first end 120 and the second end 122 to the head tube 116.

The frame 110 of the bicycle 100 further includes a first seat stay 124 and a second seat stay 126. The first seat stay 124 and the second seat stay 126 are both coupled to the seat tube 112 and extend outwardly from the seat tube 112 in a direction toward the rear wheel 104, so that the rear wheel 104 is arranged between (e.g., laterally between) the first seat stay 124 and the second seat stay 126. In some embodiments, the frame 110 further includes a first chain stay 128 and a second chain stay 130. The first chain stay 128 is coupled between the second end 122 of the seat tube 112 and the first seat stay 124, and the second chain stay 130 is coupled between the second end 122 of the seat tube 112 and the second seat stay 126. The rear wheel 104 is arranged between the first chain stay 128 and the second chain stay 130.

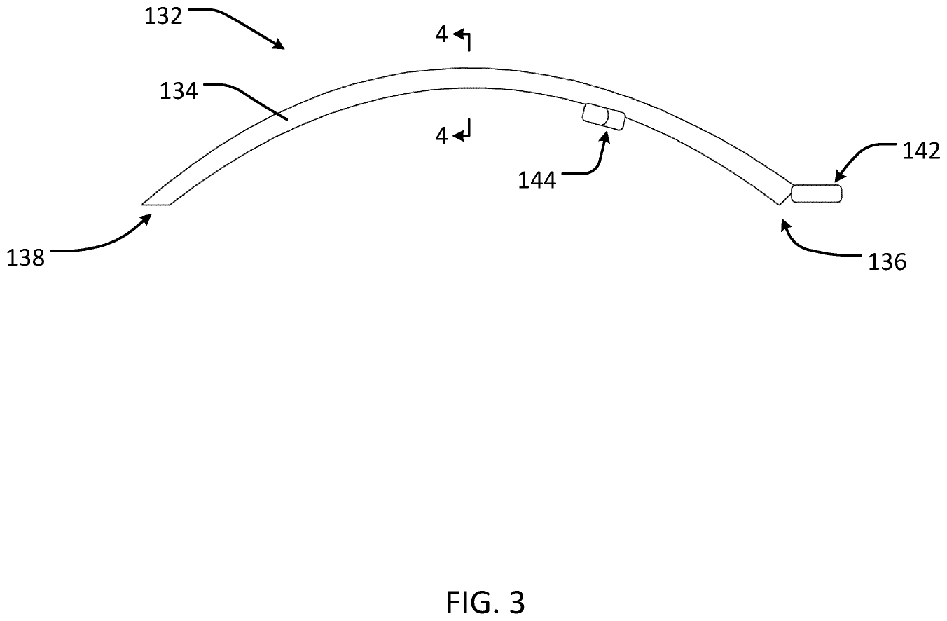

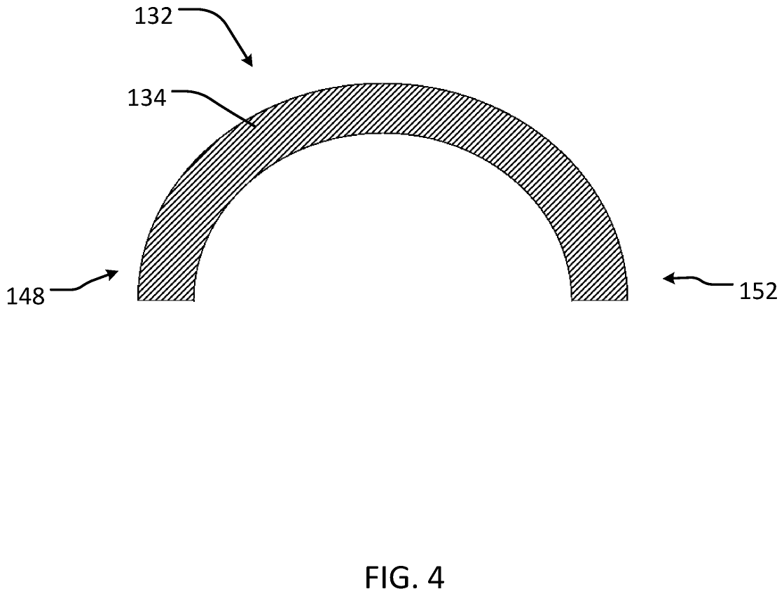

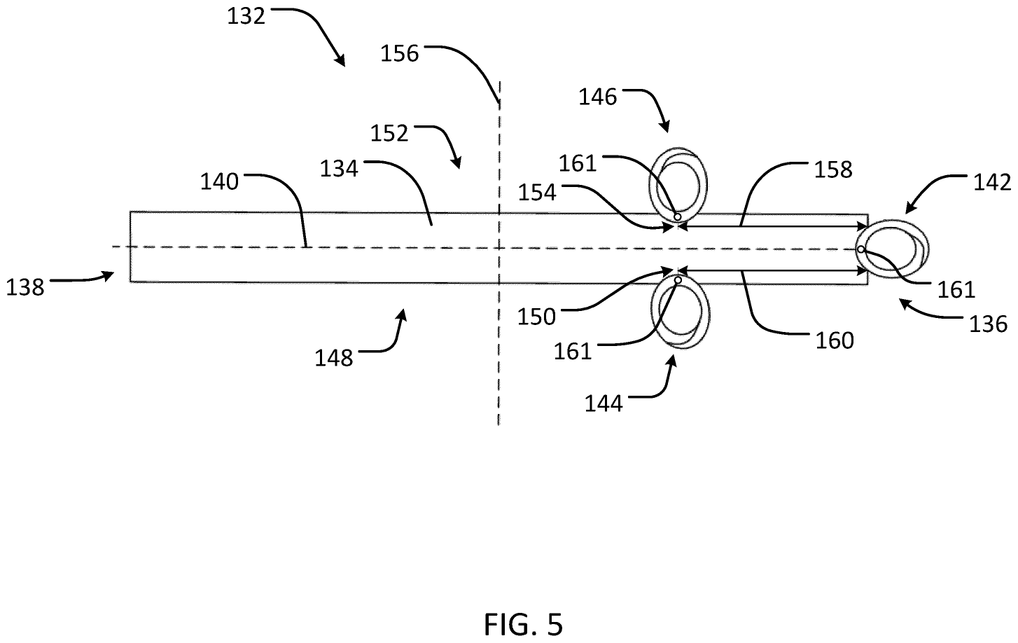

With reference to FIGS. 1-4, the bicycle 100 furth13er includes a rear fender 132 that is removable coupled to the frame 110 so that the rear fender 132 extends over a top side of the rear wheel 104. Specifically, the rear fender 132 includes a fender body 134 that extends over a top side of the rear wheel 104 and is configured to prevent water, mud, or other debris from splashing a rider of the bicycle 100. In some embodiments, the fender body 134 is fabricated from a plastic or silicone material. The fender body 134 extends longitudinally or axially between a first end 136 and a second end 138 arranged opposite to the first end 136. To conform to a shape and profile defined by the rear wheel 104, the fender body 134 defines a curved profile or shape as the fender body 134 extends longitudinally from the first end 136 to the second end 138 (see, e.g., FIG. 3). Additionally, the fender body 134 defines an arcuate or curved cross-sectional profile taken along a direction perpendicular to a longitudinal axis 140 defined by the fender body 134 (see, e.g., FIGS. 4 and 5). In some embodiments, the rear fender 132 may include one or more reflectors (e.g., sealed reflectors) positioned at various locations along the fender body 134.

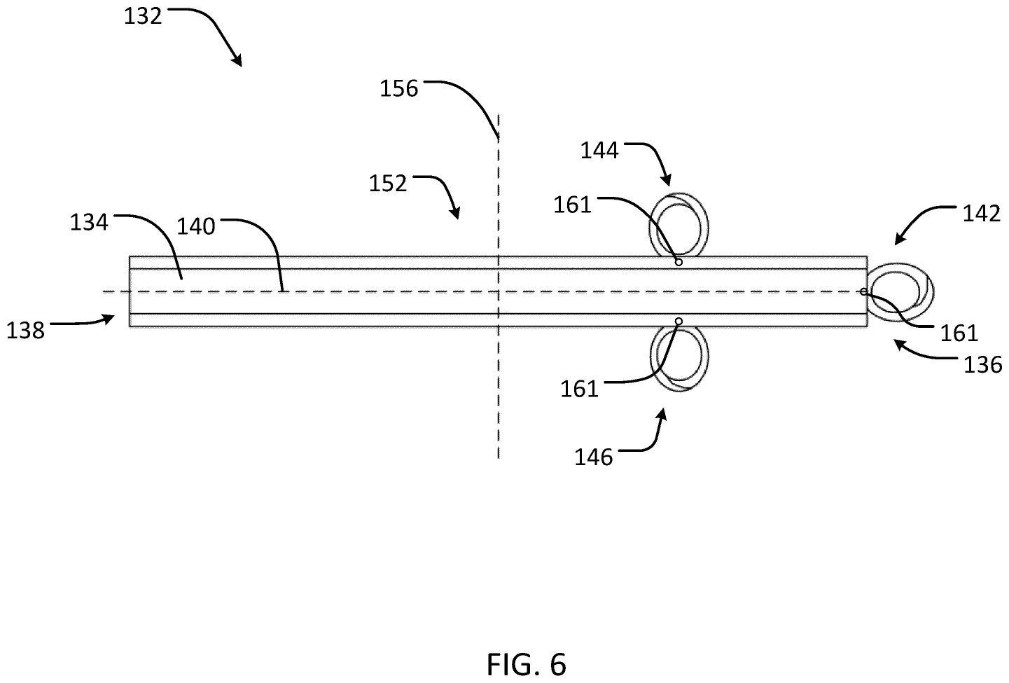

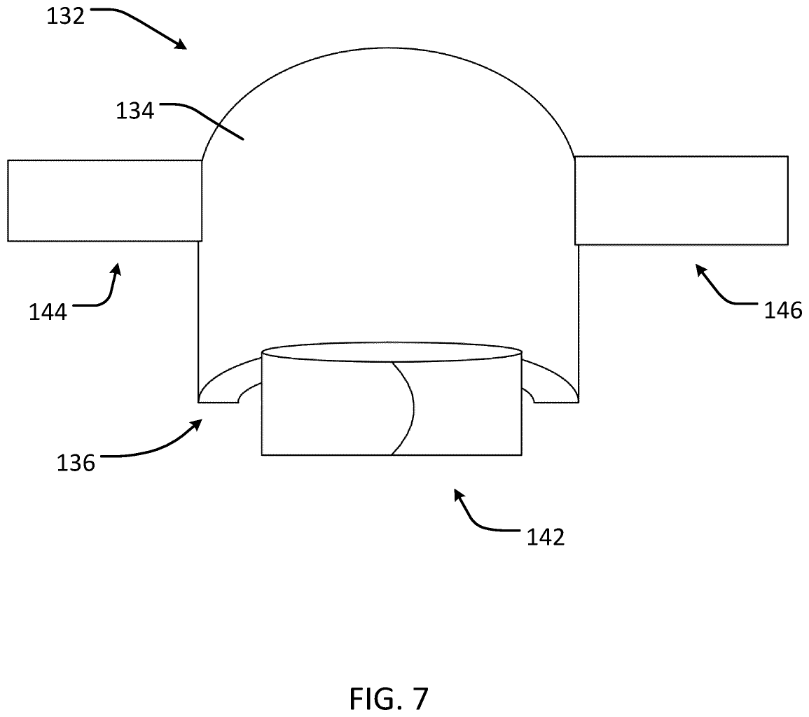

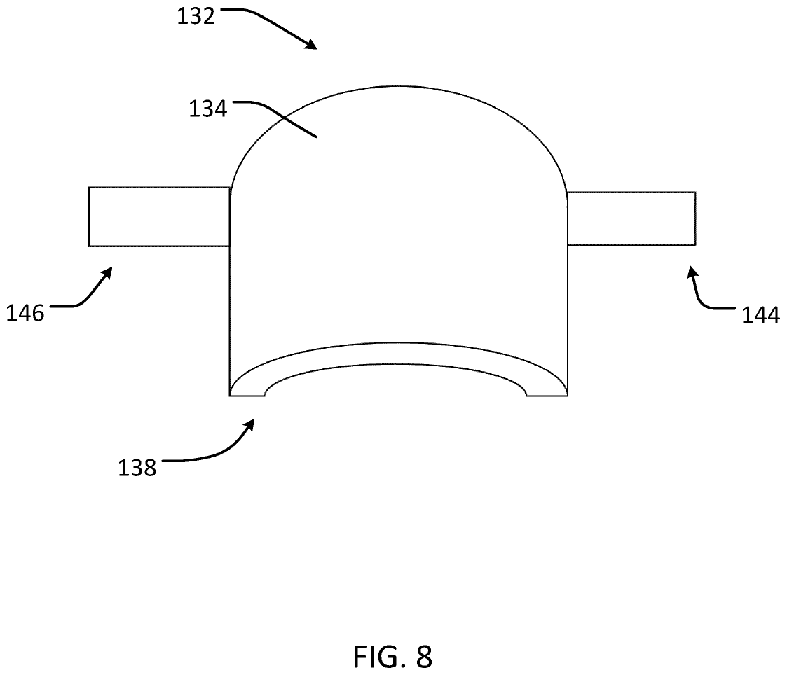

In general, the rear fender 132 includes a plurality of attachment or coupling mechanisms that enable the rear fender 132 to removably couple to various points on the frame 110 of the bicycle 100. In some embodiments, the rear fender 132 includes three attachment or coupling mechanisms that form three attachment or coupling points with the frame 110. The three attachment points may provide both longitudinal (e.g., in a direction of travel defined by the bicycle 100) and lateral (e.g., side-to-side) stability to the rear fender 132. And the attachment mechanisms may be universal to the dimensions and structure of the frame 110, so that the rear fender 132 may be selectively attached to any bicycle and frame. With reference to FIGS. 1-3 and 5-8, the rear fender 132 includes a seat attachment strap 142, a first frame attachment strap 144, and a second frame attachment strap 146. The seat attachment strap 142 is coupled to the first end 136 of the fender body 134 and is configured to removably attach to the seat tube 112. The first frame attachment strap 144 is coupled to a first side 148 of the fender body 134 at a first fender location 150 between the first end 136 and the second end 138. The second frame attachment strap 146 is coupled to a second side 152 of the fender body 134 at a second fender location 154 between the first end 136 and the second end 138. The first frame attachment strap 144 and the second frame attachment strap 146 are configured to removably attached to the first seat stay 124 and the second seat stay 126, respectively.

In some embodiments, such as in FIG. 4, the first fender location 150 is located between the first end 136 of the fender body 134 and a center axis 156 defined by the fender body 134. The center axis 156 is perpendicular to the longitudinal axis 140 defined by the fender body 134 and equidistant from the first end 136 and the second end 138. In some embodiments, the second fender location 154 is also located between the first end 136 of the fender body 134 and the center axis 156. The arrangement of the couplings between the first frame attachment strap 144 and the fender body 134 (i.e., the first fender location 150), and between the second frame attachment strap 146 and the fender body 134 (i.e., the second fender location 152) arranges the first frame attachment strap 144 and the second frame attachment strap 146 in a position adjacent to the first seat stay 124 and the second seat stay 126, when the rear fender 132 is installed on the frame 110.

In some embodiments, the first fender location 150 is separated from the first end 136 of the fender body 134 by a first distance 158 measured in a direction approximately parallel to the longitudinal axis 140, and the second fender location 154 is separated from the first end 136 of the fender body 134 by a second distance 160 measured in a direction approximately parallel to the longitudinal axis 140. In some embodiments, the first distance 158 is about equal to the second distance 160. Alternatively or additionally, the first fender location 150 and the second fender location 154 may both be located an equal distance away from the seat attachment strap 142.

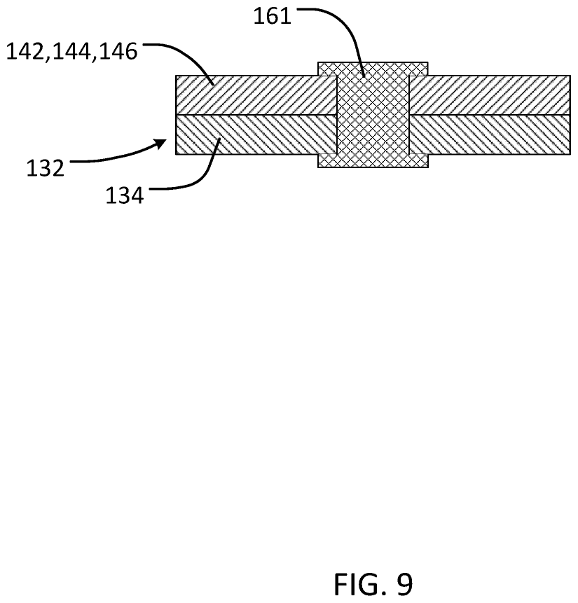

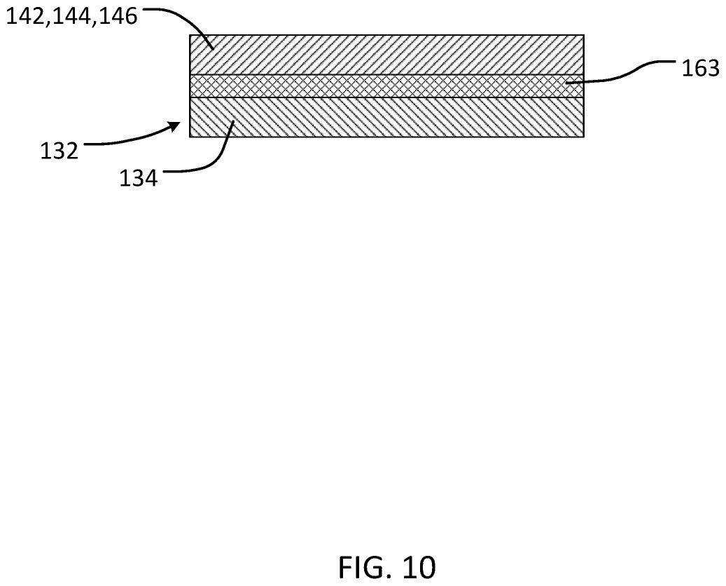

The seat attachment strap 142, first frame attachment strap 144, and second frame attachment strap 146 may be each coupled to the fender body 134, so that the seat attachment strap 142, first frame attachment strap 144, and second frame attachment strap 146 are each rigidly attached to the fender body 134. In the exemplary embodiment of FIGS. 4, 5, and 9, the seat attachment strap 142, first frame attachment strap 144, and second frame attachment strap 146 are each coupled to the fender body 134 by a mechanical fastener in the form of a rivet 161. In some embodiments, the mechanical fastener may be in the form of a screw, a bolt, or an equivalent fastening element. In some embodiments, as shown in FIG. 10, the seat attachment strap 142, first frame attachment strap 144, and second frame attachment strap 146 are each coupled to the frame body 134 using an adhesive 163 (e.g., an epoxy adhesive, a glue, or an equivalent adhesive).

The seat attachment strap 142, first frame attachment strap 144, and second frame attachment strap 146 are configured such that they can be removably coupled to parts of the frame 110 of the bicycle 100. For example, each of the seat attachment strap 142, first frame attachment strap 144, and second frame attachment strap 146 includes or is formed by a hook and loop fastener that may be selectively installed around various portions of the frame 110 to secure the rear fender 132 to the frame 110. As shown in FIGS. 1, 2, and 11, for example, the seat attachment strap 142 is coupled to the seat tube 112 at a location between the first end 120 of the seat tube 112 and the second end 122 of the seat tube 112. Specifically, the seat attachment strap 142 is coupled to the seat tube 112 at a location between the second end 122 and a location where the first seat stay 124 and the second seat stay 126 are coupled to seat tube 112. As shown in FIGS. 1, 2, and 10, for example, the first frame attachment strap 144 is coupled to the first seat stay 124, and the second frame attachment strap 146 is coupled to the second seat stay 126. These three connections provide a secure attachment of the rear fender 132 to the frame 110 of the bicycle 100.

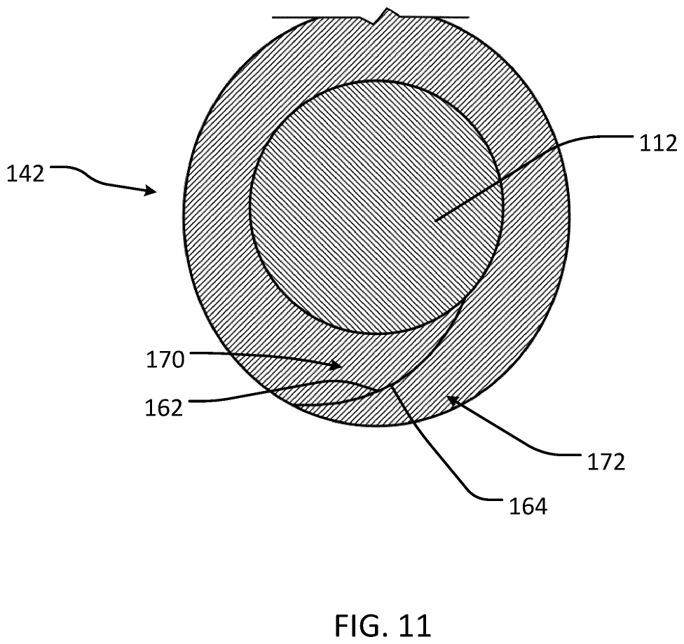

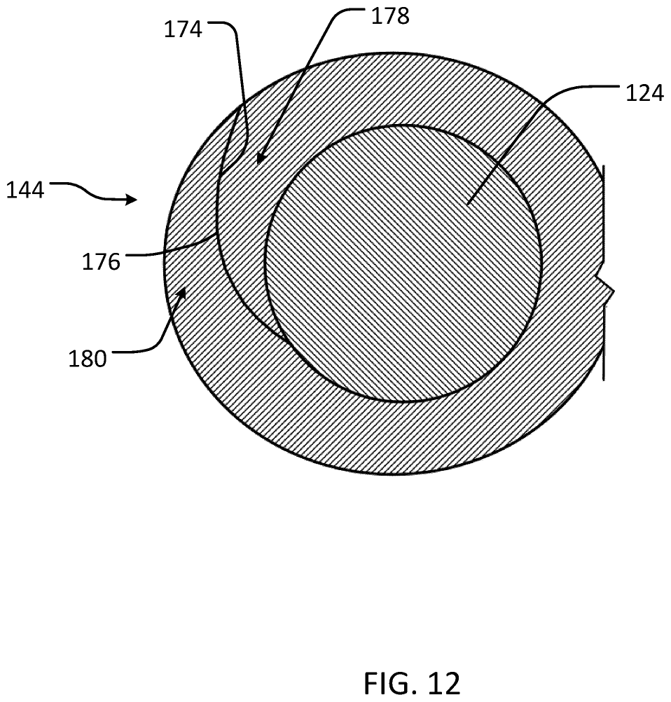

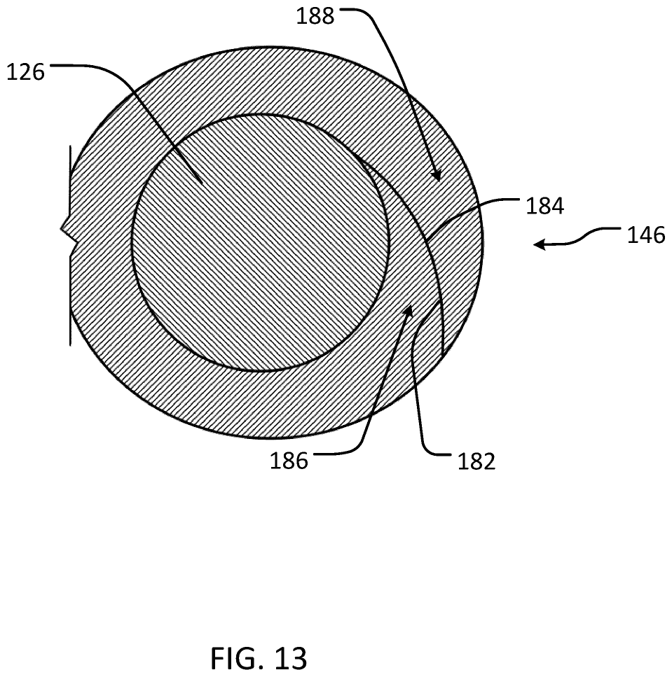

As shown in FIG. 11, for example, the seat attachment strap 142 has a first end 170 having a hook surface 162 and a second end 172 having a loop surface 164. The hook surface 162 of the first end 170 and the loop surface 164 of the second end 172 together from a hook and loop fastener. To install the rear fender 132 to the bicycle 100, the seat attachment strap 142 may be wrapped around the seat tube 112 such that the loop surface 164 of the second end 172 overlaps the hook surface 162 of the first end 170. Pressure may be applied to the seat attachment strap 142 such that a part of the hook surface 162 of the first end 170 contacts and secures to a part of the loop surface 164 of the second end 172. Similarly, as shown in FIG. 12, for example, the first frame attachment strap 144 may be secured around the first seat stay 124. The first frame attachment strap 144 may be wrapped around the first seat stay 124 and pressed such that a loop surface 176 of a second end 180 overlaps, contacts, and secures to a hook surface 174 of a first end 178. As shown in FIG. 13, for example, this process may also be repeated such that the second frame attachment strap 146 is secured around the second seat stay 126. The second frame attachment strap 146 may be wrapped around the second seat stay 126 and pressed such that a loop surface 184 of a second end 188 overlaps, contacts, and secures to a hook surface 182 of a first end 186. This method of installing the rear fender 132 can be completed quickly and without the use of tools, and it provides a secure connection of the rear fender 132 to the frame 110 of the bicycle 100, while being universal to the design and structure of the frame 110.

In various embodiments in which the seat attachment strap 142, the first frame attachment strap 144, and the second frame attachment strap 146 are hook and loop fasteners, the rear fender 132 is quickly and easily removable from the bicycle 100. To detach the seat attachment strap 142, the first end 170 may be pulled away from the second end 172, which allows the seat attachment strap 142 to be unwrapped from around the seat tube 112. This process may be repeated with the first frame attachment strap 144 and the second frame attachment strap 146 to remove the rear fender 132 without the use of tools.

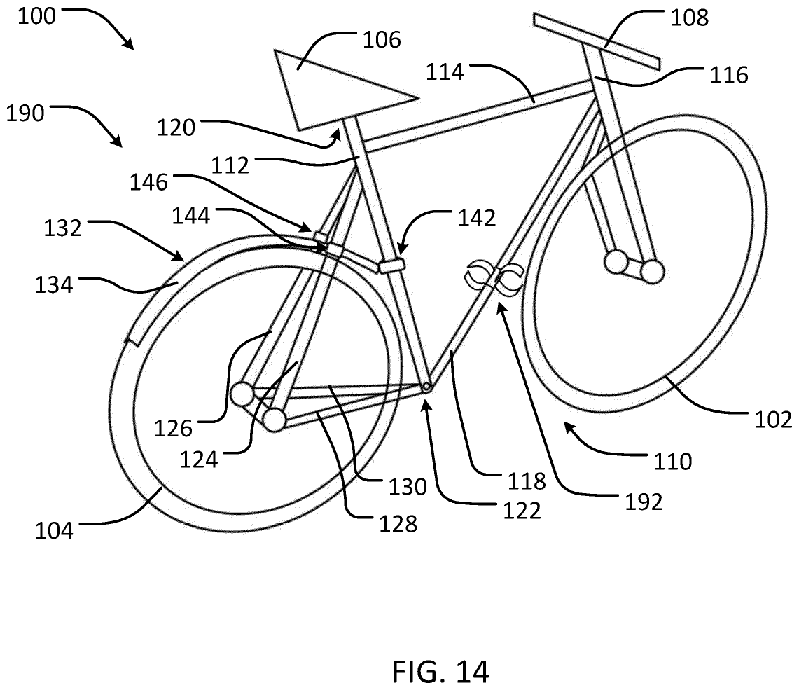

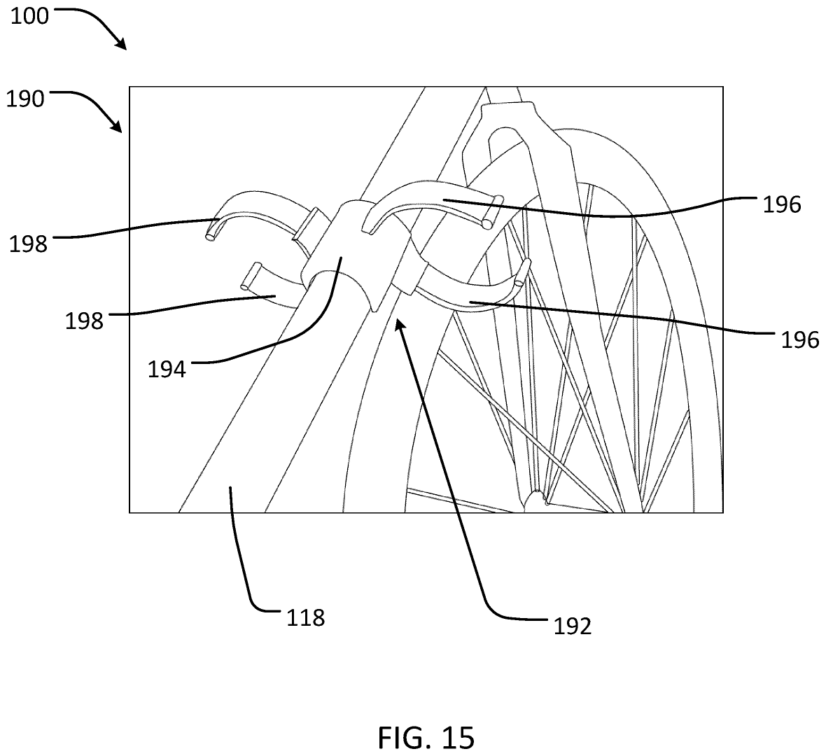

With reference to FIGS. 14 and 15, in some embodiments, the rear fender 132 is included in a kit 190 that includes a bottle holder 192 that is configured to removably attach to the down tube 118. In some embodiments, the bottle holder 192 includes a U-shaped base 194 that is designed to snap on to the down tube 118 by a rider pressing the bottle holder 192 onto the down tube 118 at a particular location. In the exemplary embodiment, the bottle holder 192 includes a first pair of holder arms 196 that extend outwardly from a first side of the base 194 and a second pair of holder arms 198 that extend outwardly from a second side of the base 194 that is opposite to the first side. Each pair of holder arms 196, 198 is configured to receive a bottle and secure the bottle to the frame 110. In some embodiments, an upper arm in each of the pair of holder arms 196, 198 is adjustable relative to the base 194 so that a rider may push the upper arms into the base 194 or pull the upper arms out of the base 194 to adjust a diameter of a bottle that may be received by the holder arms 196, 198.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the bicycle 100 and the rear fender 132 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A rear fender for a bicycle, the rear fender comprising:
a fender body including a first end, and a second end arranged opposite to the first end, wherein the fender body defines a curved profile as the fender body extends from the first end to the second end;
a seat attachment strap coupled to the first end of the fender body;
a first frame attachment strap coupled to a first side of the fender body at a first fender location between the first end and the second end; and
a second frame attachment strap coupled to a second side of the fender body, opposite to the first side, at a second fender location between the first end and the second end.

2. The rear fender of claim 1, wherein the fender body defines an arcuate cross-section profile taken along a direction perpendicular to a longitudinal axis defined by the fender body.

3. The rear fender of claim 1, wherein the seat attachment strap, the first frame attachment strap, and the second frame attachment strap are hook and loop fasteners.

4. The rear fender of claim 1, wherein the seat attachment strap, the first frame attachment strap, and the second frame attachment strap are each coupled to the fender body with an epoxy adhesive.

5. The rear fender of claim 1, wherein the seat attachment strap, the first frame attachment strap, and the second frame attachment strap are each coupled to the fender body with one or more mechanical fasteners.

6. The rear fender of claim 1, further comprising a center axis perpendicular to a longitudinal axis defined by the fender body and equidistant from the first end and the second end, wherein the first fender location is located between the first end and the center axis.

7. The rear fender of claim 6, wherein the second fender location is located between the first end and the center axis.

8. The rear fender of claim 7, wherein the first fender location is separated from the first end by a first distance and the second fender location is separated from the first end by a second distance, wherein the first distance is equal to the second distance.

9. A rear fender for a bicycle having a seat tube, a first seat stay extending outwardly from the seat tube, and a second seat stay extending outwardly the seat tube, the rear fender comprising:
a fender body including a first end and, a second end arranged opposite to the first end, wherein the fender body defines a curved profile as the fender body extends from the first end to the second end;
a seat attachment strap coupled to the first end of the fender body and configured to removably attach to the seat tube;
a first frame attachment strap coupled to a first side of the fender body at a first fender location between the first end and second end and configured to removably attach to the first seat stay; and
a second frame attachment strap coupled to a second side of the fender body at a second fender location between the first end and the second end and configured to removably attach to the second seat stay.

10. The rear fender of claim 9, wherein the fender body defines an arcuate cross-section profile taken along a direction perpendicular to a longitudinal axis defined by the fender body.

11. The rear fender of claim 9, wherein the seat attachment strap, the first frame attachment strap, and the second frame attachment strap are hook and loop fasteners.

12. The rear fender of claim 9, wherein the seat attachment strap, the first frame attachment strap, and the second frame attachment strap are each coupled to the fender body with an epoxy adhesive.

13. The rear fender of claim 9, wherein the seat attachment strap, the first frame attachment strap, and the second frame attachment strap are each coupled to the fender body with one or more mechanical fasteners.

14. The rear fender of claim 9, further comprising a center axis perpendicular to a longitudinal axis defined by the fender body, wherein the center axis is equidistant from the first end and the second end, and wherein the first fender location is located between the first end and the center axis.

15. The rear fender of claim 14, wherein the second fender location is located between the first end and the center axis.

16. The rear fender of claim 15, wherein the first fender location is separated from the first end by a first distance and the second fender location is separated from the first end by a second distance, wherein the first distance is equal to the second distance.

17. A rear fender for a bicycle, the rear fender comprising:
a fender body including a first end and a second end arranged opposite to the first end, wherein the fender body defines a curved profile as the fender body extends from the first end to the second end;
a center axis perpendicular to a longitudinal axis defined by the fender body, wherein the center axis is equidistant from the first end and the second end;
a seat attachment strap coupled to the first end of the fender body, wherein the seat attachment strap is a hook and loop fastener;
a first frame attachment strap coupled to a first side of the fender body at a first fender location between the seat attachment strap and the center axis, wherein the first frame attachment strap is a hook and loop fastener, and wherein the first fender location is separated from the seat attachment strap by a first distance; and
a second frame attachment strap coupled to a second side of the fender body, opposite to the first side, at a second fender location between the seat attachment strap and the center axis, wherein the second frame attachment strap is a hook and loop fastener, and wherein the second fender location is separated from the seat attachment strap by a second distance equal to the first distance.

18. The rear fender of claim 17, wherein the fender body defines an arcuate cross-section profile taken along a direction perpendicular to a longitudinal axis defined by the fender body.

19. The rear fender of claim 17, wherein the seat attachment strap, the first frame attachment strap, and the second frame attachment strap are each coupled to the fender body with an epoxy adhesive.

20. The rear fender of claim 17, wherein the seat attachment strap, the first frame attachment strap, and the second frame attachment strap are each coupled to the fender body with one or more mechanical fasteners.
